(19) United States
(12) Patent Application Publication
(10) Pub. No.: US 2014/0192010 A1
(43) Pub. Date: Jul. 10, 2014

(54) Capacitive Touch Panel

(71) Applicant: NOVATEK Microelectronics Corp., Hsin-Chu (TW)

(72) Inventors: Chih-Chang Lai, Taichung City (TW); Shih-Ming Lin, Hsinchu City (TW)

(73) Assignee: NOVATEK Microelectronics Corp., Hsin-Chu (TW)

(21) Appl. No.: 13/966,267

(22) Filed: Aug. 13, 2013

(30) Foreign Application Priority Data
Jan. 10, 2013 (TW) 102100883

(51) Int. Cl. G06F 3/044

(52) U.S. Cl. CPC G06F 3/044
USPC 345/174

(57) ABSTRACT

A capacitive touch panel is disclosed to include a plurality of sensing channels disposed along a first direction and a second direction, respectively, and including a plurality of sensing modules. Each of the plurality of sensing modules includes a sensing unit and a plurality of dummy units being separately disposed to form a plurality of boundaries. A plurality of extension rays of the plurality of boundaries, the first direction and the second direction are interlaced to form a plurality of angles being in the range from zero degrees to ninety degrees or from ninety degrees to a hundred and eighty degrees. A plurality of connecting units is disposed along the first direction and the second direction for connecting the plurality of sensing modules. The first direction is perpendicular to the second direction and the plurality of sensing channels is perpendicular to each other on a projective plane.

### BACKGROUND OF THE INVENTION

1. Field of the Invention

The present invention relates to a capacitive touch panel, and more particularly, to a capacitive touch panel which comprises a plurality of dummy units and a plurality of boundaries for effectively reducing a touch area of the capacitive touch panel and maintaining a symmetrical structure thereof.

2. Description of the Prior Art

Due to more intuitive and convenient operation, a touch control display device has been widely adopted among electrical products. Generally, the touch control display device comprises a display panel and a transparent touch panel. Through attachment of the transparent touch panel onto the display panel, the touch control display device can realize touch control functions as well as display functions. Currently, capacitive touch control is the most popular.

Please refer to FIG. 1, which illustrates a schematic diagram of a conventional capacitive touch panel 10. For simplicity, only partial elements are depicted for illustration. As shown in FIG. 1, the capacitive touch panel 10 comprises a plurality of rhombus shaped electrode units having the same sizes and is formed as a two-layer structure, wherein one layer of the capacitive touch panel 10 is utilized as a driving zone comprising a plurality of electrode units 100 parallel to the Y-axis, and another layer of the capacitive touch panel 10 is utilized as a reception zone comprising a plurality of electrode units 102 parallel to the X-axis. Each of the plurality of electrode units 100, 102 is sequentially connected via connecting units 1000, 1020, such that the plurality of electrode units 100, 102 are electrically connected. Preferably, after an initiation signal is received by the plurality of electrode units 100, the plurality of electrode units 102 are utilized to detect whether a user touches the capacitive touch panel 10 to generate a capacitive effect, where a sensing signal is generated as well, so as to position a touch position of the user. Although the plurality of electrode units 100, 102 cover almost all areas of the capacitive touch panel 10, which can effectively enhance detection efficiency of the plurality of electrode units 100, 102, extra noise signals can be also generated to decrease accurate determination of the touch position.

Please refer to FIG. 2, which illustrates a schematic diagram of another conventional capacitive touch panel 20. For simplicity, only partial elements are depicted for illustration. As shown in FIG. 2, the capacitive touch panel 20 is similar to the capacitive touch panel 10 shown in FIG. 1, and comprises a plurality of electrode units 200 parallel to the Y-axis and a plurality of electrode units 202 parallel to the X-axis. The plurality of electrode units 200, 202 are connected via the connecting units 2000, 2002. The only difference is that the capacitive touch panel 20 further comprises a plurality of dummy units 2002, 2022, and the plurality of dummy units 2002, 2022 are not electrically connected to the plurality of electrode units 200, 202. Under such circumstances, the capacitive touch panel utilizes the plurality of dummy units 2002, 2022 to reduce a touch area, so as to effectively eliminate generation of the noise signal. In the meanwhile, a symmetrical structure of the plurality of dummy units 2002, 2022 and the plurality of electrode units is maintained as well, such that the driving zone and the reception zone can be functionally operated for the driving operation as well as the sensing operation. However, when the capacitive touch panel is integrated with a display device, the symmetrical structure of the capacitive touch panel 20 can easily cause interference of lights to result in discomfort observation for the users.

Therefore, it has been an important issue to provide a capacitive touch panel which effectively reduces the touch area thereof for less noise signal generation and avoids utilizing the symmetrical structure for less interference of lights.

### SUMMARY OF THE INVENTION

It is therefore an objective of the invention to provide a capacitive touch panel which comprises a plurality of dummy units and a plurality of boundaries to effectively reduce a touch area of the capacitive touch panel and maintain a symmetrical structure thereof, so as to decrease the noise signal generation as well as the interference of lights and to enlarge the application range of the capacitive touch panel.

According to an aspect of the disclosure, a capacitive touch panel is provided. The capacitive touch panel comprises a plurality of first sensing channels disposed along a first direction, and each of the plurality of first sensing channels comprises a plurality of first sensing modules, and each of the first sensing modules comprises a first sensing unit, a plurality of first dummy units disposed to one side of the first sensing unit, and a plurality of second dummy units disposed to another side of the first sensing unit, wherein the plurality of first dummy units and the plurality of second dummy units are separately disposed to form a plurality of first boundaries, and a plurality of extension rays derived from the plurality of first boundaries and another extension ray of the first direction are interlaced to form a plurality of first angles being in the range from zero degrees to ninety degrees or from ninety degrees to a hundred and eighty degrees. Each of the plurality of first sensing channels further comprises a plurality of first connecting units disposed along the first direction for connecting the plurality of first sensing modules. The capacitive touch panel further comprises a plurality of second sensing channels disposed along a second direction, and each of the plurality of second sensing channels comprises a plurality of second sensing modules, and each of the second sensing modules comprises a second sensing unit, a plurality of third dummy units disposed to one side of the second sensing unit, and a plurality of fourth dummy units disposed to another side of the second sensing unit, wherein the plurality of third dummy units and the plurality of fourth dummy units are separately disposed to form a plurality of second boundaries, and a plurality of extension rays derived from the plurality of second boundaries and another ray of the second direction are interlaced to form a plurality of second angles being in the range from zero degrees to ninety degrees or from ninety degrees to a hundred and eighty degrees. Each of the second sensing channels further comprises a plurality of second connecting units disposed along the second direction for connecting the plurality of second sensing modules. The first direction is perpendicular to the second direction, such that the plurality of first sensing channels and the plurality of second sensing channels are perpendicular to each other on a projective plane.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a conventional capacitive touch panel.

FIG. 2 illustrates a schematic diagram of another conventional capacitive touch panel.

FIG. 3 illustrates a schematic diagram of a capacitive touch panel according to an embodiment of the invention.

FIG. 4 to FIG. 7 illustrate schematic diagrams of other capacitive touch panels according to embodiments of the invention.

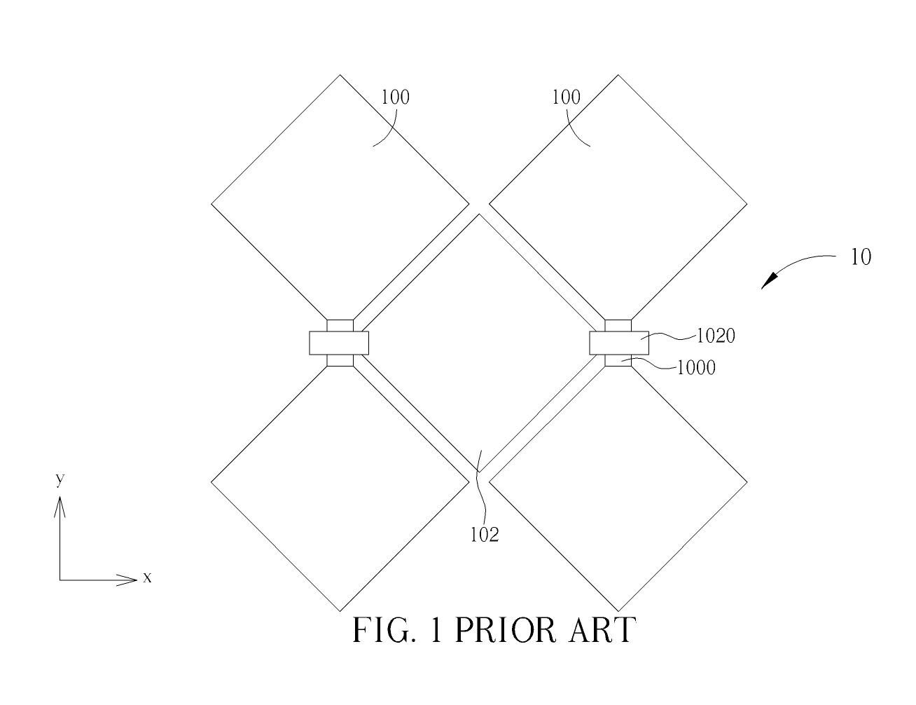

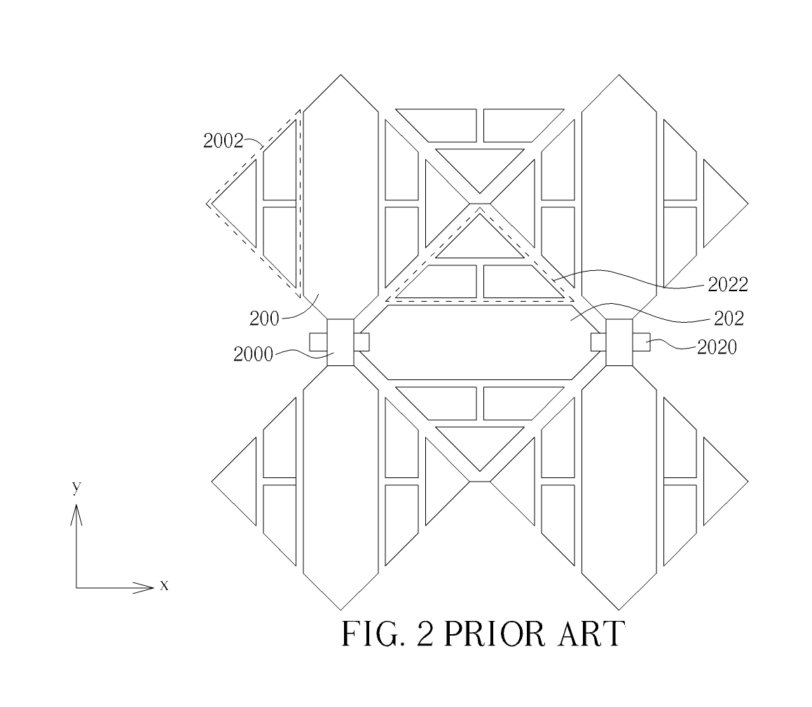

### DETAILED DESCRIPTION

The specification and the claims of the present invention may use a particular word to indicate an element, which may have diversified names named by distinct manufacturers. The present invention distinguishes the element depending on its function rather than its name. The phrase “comprising” used in the specification and the claims is to mean “is inclusive or open-ended but not exclude additional, un-recited elements or method steps.” In addition, the phrase “electrically connected to” or “coupled” is to mean any electrical connection in a direct manner or an indirect manner. Therefore, the description of “a first device electrically connected or coupled to a second device” is to mean that the first device is connected to the second device directly or by means of connecting through other devices or methods in an indirect manner.

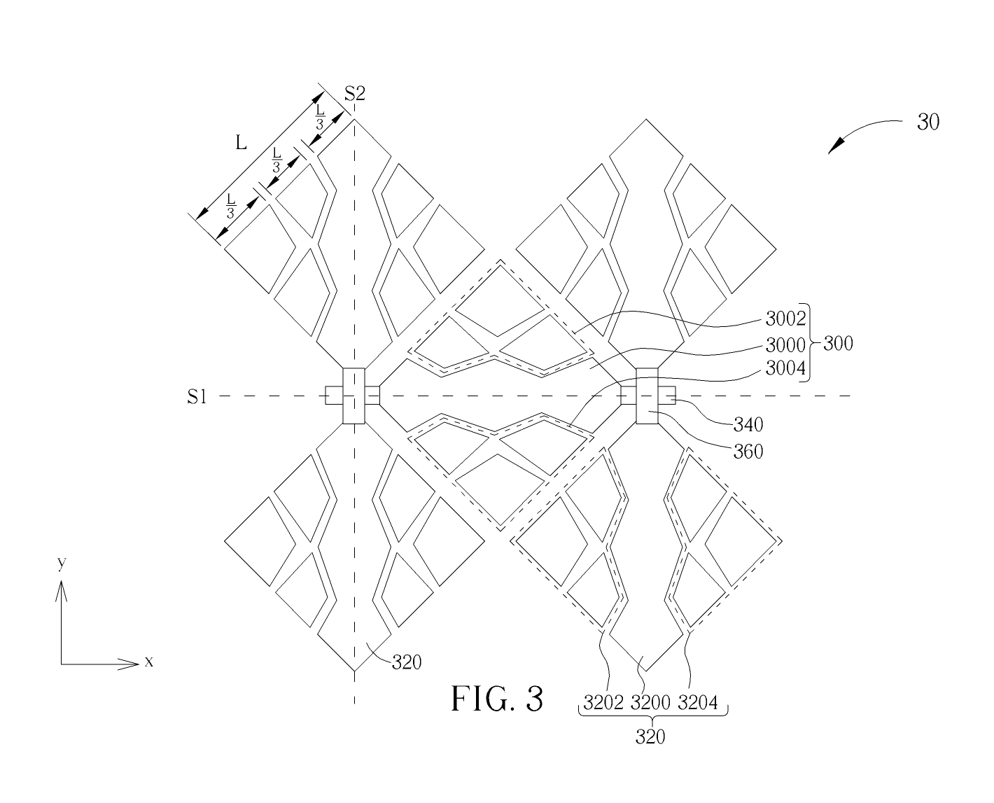

Please refer to FIG. 3, which illustrates a schematic diagram of a capacitive touch panel 30 according to an embodiment of the invention. For simplicity, only partial elements are depicted for illustration. In the embodiment, the capacitive touch panel 30 is interlaced by a plurality of transparent electrodes to form independent arrays as a driving zone as well as a reception zone. Certainly, the capacitive touch panel 30 can also be integrated with a display device (not shown in the figure) to further comprise a flexible printed circuit board (PCB), a light guide plate, a backlight module and a display panel, which is not limiting the scope of the invention.

As shown in FIG. 3, the capacitive touch panel 30 is located on an XY plane to comprise a plurality of first sensing channels S1 and a plurality of second sensing channels S2. Each of the plurality of first sensing channels S1 is parallel to the X-axis to be disposed with an equal distance, and each of the plurality of second sensing channels S2 is parallel to the Y-axis to be disposed with another equal distance. Also, each of the plurality of first sensing channels S1 comprises a plurality of first sensing modules 300 and a plurality of first connecting units 340, and each of the plurality of second sensing channels S2 comprises a plurality of second sensing modules 320 and a plurality of second connecting units 360. Besides, each first sensing module 300 is formed as a rhombus shaped structure and comprises a first sensing unit 3000, a plurality of first dummy units 3002 and a plurality of second dummy units 3004, and each second sensing module 320 is also formed as a rhombus shaped structure and comprises a second sensing unit 3200, a plurality of third dummy units 3202 and a plurality of fourth dummy units 3204. Preferably, the plurality of first connecting units 340 and the plurality of second connecting unit 360 are formed as rectangular structures (or oblong forms), such that the embodiment of the invention can directly utilize a pair of right angles of the first connecting unit 340 to connect with two of the plurality of first sensing module 300 along the X-axis, so as to form the plurality of first sensing channels S1. Also, the embodiment of the invention can directly utilize a pair of right angles of the second connecting unit 360 to connect with two of the plurality of second sensing module 320 along the Y-axis, so as to form the plurality of second sensing channels S2, such that the plurality of first sensing channels S1 and the plurality of second sensing channels S2 are perpendicular to each other on a projection plane and form a plurality of vertical lines as well as a plurality of horizontal lines interlaced to each other as a chessboard.

Simply, the embodiment of the invention provides the capacitive touch panel 30 located on the XY plane to comprise the plurality of first sensing channels S1 parallel to the X-axis and the plurality of second sensing channels S2 parallel to the Y-axis, wherein each of the plurality of first sensing channels S1 comprises the plurality of first sensing modules 300 to be electrically connected via the plurality of first connecting units 340 along the X-axis, and each of the plurality of second sensing channels S2 comprises the plurality of second sensing modules 320 to be electrically connected via the plurality of second connecting units 360 along the Y-axis. Thus, the plurality of first sensing units 3000 and the plurality of second sensing units 3200 are equally disposed on the projection plane of the capacitive touch panel 30. Furthermore, considering each first sensing module 300, the first sensing unit 3000 is located on a horizontal diagonal line of the rhombus shaped structure, and the plurality of first dummy units 3002 as well as the plurality of second dummy units 3004 are symmetrically disposed to the horizontal diagonal line for neighboring above/below the first sensing unit 3000. Preferably, in the embodiment of the invention, the first sensing unit 3000 comprises a plurality of concave/convex parts, a number of the first/second dummy units is three, and each first/second dummy unit is a quadrilateral shape to comprise two obtuse angles and two acute angles. Under such circumstances, the first sensing unit 3000, the plurality of first dummy units 3002 and the plurality of second dummy units 3004 can utilize the mentioned plurality of concave/convex parts as well as the obtuse/acute angles to be closely disposed together forming the rhombus shaped structure, wherein a plurality of cavities are obtained via the plurality of concave/convex parts as well as the obtuse/acute angles, or it can be regarded as the first sensing unit 3000, the plurality of first dummy units 3002 and the plurality of second dummy units 3004 further comprise a plurality of first boundaries. The plurality of first boundaries can derive a plurality of extension rays, and the plurality of extension rays intersect with the X-axis and the Y-axis to form a plurality of first angles, wherein values of the plurality of first angles are bigger than zero degrees, smaller than a hundred and eighty degrees and not equal to ninety degrees, i.e. the values of the plurality of first angles are in the range from zero degrees to ninety degrees or from ninety degrees to a hundred and eighty degrees or it can be regarded as the plurality of first angles are not parallel or perpendicular to the X-axis and the Y-axis. In comparison with the prior art, the plurality of first dummy units 3002 and the plurality of second dummy units 3004 of the embodiment are not symmetrical quadrilaterals, and accordingly, a plurality of boundaries derived from the asymmetrical quadrilaterals are not parallel/perpendicular to the X-axis and the Y-axis to avoid generation of light interference.

Moreover, considering each second sensing module 320 being similar to each first sensing module 300, the second sensing unit 3200 is on a vertical diagonal line of the rhombus shaped structure, and the plurality of third dummy units 3202 as well as the plurality of fourth dummy units 3204 are symmetrically disposed to the vertical diagonal line for neighboring left/right side of the second sensing unit 3200. Preferably, in the embodiment of the invention, the second sensing unit 3200 comprises a plurality of concave/convex parts, a number of the third/fourth dummy units is three, and each third/fourth dummy unit is quadrilateral shaped to comprise two obtuse angles and two acute angles. Under such circumstances, the second sensing unit 3200, the plurality of third dummy units 3202 and the plurality of fourth dummy units 3204 can utilize the mentioned plurality of concave/convex parts as well as the obtuse/acute angles to be closely disposed together forming the rhombus shaped structure, wherein a plurality of cavities are obtained via the plurality of concave/convex parts as well as the obtuse/acute angles, or it can be regarded as the second sensing unit 3200, the plurality of third dummy units 3202 and the plurality of fourth dummy units 3204 further comprise a plurality of second boundaries. The plurality of second boundaries can derive a plurality of extension rays, and the plurality of extension rays intersect with the X-axis and the Y-axis to form a plurality of second angles, wherein values of the plurality of second angles are bigger than zero degrees, smaller than a hundred and eighty degrees and not equal to ninety degrees, i.e. the values of the plurality of second angles are in the range from zero degrees to ninety degrees or from ninety degrees to a hundred and eighty degrees or it can be regarded as the plurality of second angles are not parallel or perpendicular to the X-axis and the Y-axis. In comparison with the prior art, the shapes of plurality of third dummy units 3202 and the plurality of fourth dummy units 3204 of the embodiment are not symmetrical quadrilaterals, and accordingly, a plurality of boundaries derived from the asymmetrical quadrilateral shapes are not parallel/perpendicular to the X-axis and the Y-axis to avoid generation of light interference.

Under such circumstances, the plurality of first sensing modules 300 and the plurality of second sensing modules 320 of the embodiments comprise the plurality of dummy units and each dummy units is shaped as an asymmetrical quadrilateral, such that the plurality of boundaries are not parallel/perpendicular to the X-axis and the Y-axis to avoid generation of light interference. In the meanwhile, the symmetrical structure of the plurality of first sensing modules 300 and the plurality of second sensing modules 320 is obtained as well. Besides, in the embodiment, the rhombus shaped structure of each of the plurality of first sensing modules 300 (or the plurality of second sensing modules 320) comprises four sides with equal length, and the first sensing unit 3000 (or the second sensing unit 3200) and the plurality of the dummy units comprise a side sharing the equal length to be utilized to form the side of the rhombus shaped structure. In other words, a side length of the first sensing unit 3000 (or the second sensing unit 3200) and the plurality of the dummy units is one third of a side length of the rhombus shaped structure. For example, the rhombus shaped structure of the second sensing module 320 in the upper left corner of the FIG. 3 comprises a length marked as L, and the second sensing unit 3200 and the third dummy units 3202 comprise one side marked as L/3. Certainly, the other plurality of first sensing modules 300 and the other plurality of second sensing modules 320 share the same composition ratio of the side length, and, concerning clear illustration, the corresponding marks can be saved. Additionally, every two rhombus shaped structures of the first sensing module 300 and the second sensing module 320 are separately disposed via a first distance of 30 um, and widths of the plurality of boundaries are equal to the first distance as 30 um, where the above number is disclosed as illustration and is not limiting the scope of the invention.

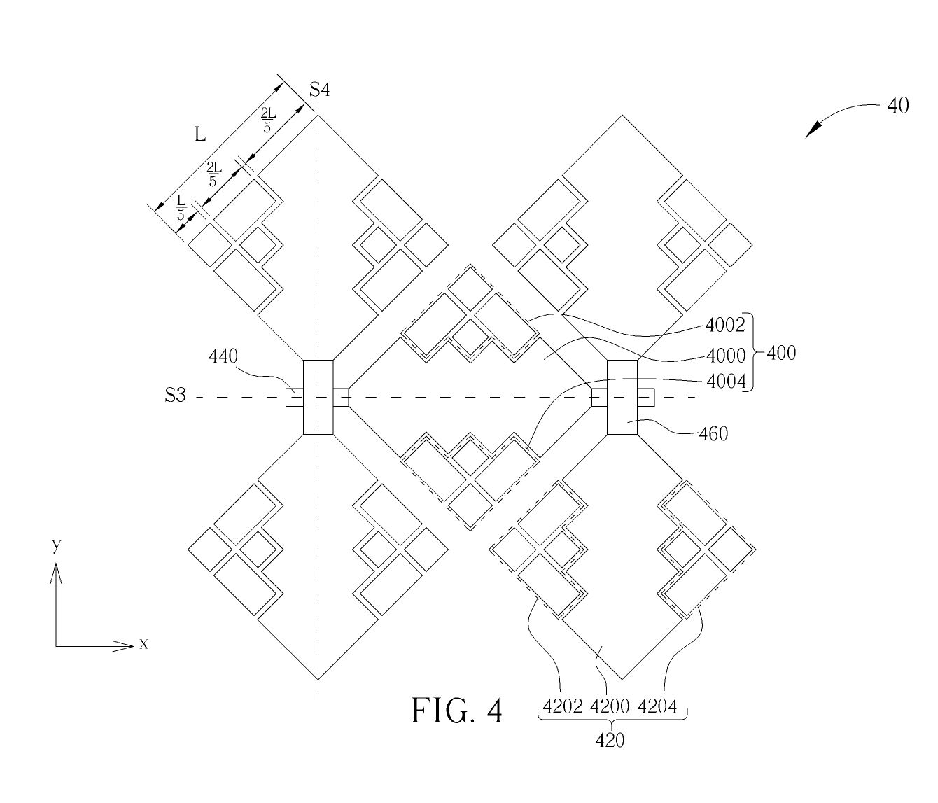

Please refer to FIG. 4, which illustrates a schematic diagram of another capacitive touch panel 40 according to an embodiment of the invention. As shown in FIG. 4, the capacitive touch panel 40, being similar to the capacitive touch panel 30 shown in FIG. 3, also comprises a plurality of first sensing channels S3 and a plurality of second sensing channels S4 being disposed with equal distance, and each of the plurality of first sensing channels S3 is parallel to the X-axis and each of the plurality of second sensing channels S4 is parallel to the Y-axis. Also, each first sensing channel S3 comprises a plurality of first sensing modules 400 and a plurality of first connecting units 440, and each second sensing channel S4 comprises a plurality of second sensing modules 420 and a plurality of second connecting units 460. Besides, each first sensing module 400 is formed as a rhombus shaped structure and comprises a first sensing unit 4000, a plurality of first dummy units 4002 and a plurality of second dummy units 4004, and each second sensing module 420 is also formed as a rhombus shaped structure and comprises a second sensing unit 4200, a plurality of third dummy units 4202 and a plurality of fourth dummy units 4204. Noticeably, the plurality of first dummy units 4002, the plurality of second dummy units 4004, the plurality of third dummy units 4202 and the plurality of fourth dummy units 4204 are formed shaped as quadrilaterals with a number of four, and particularly, the above quadrilaterals are obtained as a square or a rectangular shape. Accordingly, a plurality of first boundaries and a plurality of second boundaries are generated to be parallel/perpendicular to each other. Further, the plurality of first boundaries and the plurality of second boundaries can also be parallel/perpendicular to a side of the rhombus shaped structure corresponding to the first sensing module 400 (or the second sensing module 420). Certainly, those skilled in the art can adaptively combine/modify/adjust the embodiments shown in FIG. 3 and FIG. 4 to correspondingly derive embodiments comprising a plurality of boundaries related to a plurality of dummy units and the plurality of sensing units, such that a plurality of derived extension rays are not parallel/perpendicular to the X-axis and the Y-axis, which is also in the scope of the invention.

Considering a structure condition of the capacitive touch panel 40, the second sensing module 420 of the upper left corner of the FIG. 4 has the rhombus shaped structure comprising a side length as L, the second sensing unit 4200 comprises a side length as 2L/5, and the third dummy units 4202 comprises a side length as 2L/5 or L/5. Certainly, the other plurality of first sensing modules 400 and the other plurality of second sensing modules 420 comprise the same composition ratio of the side length, and, concerning brevity, the corresponding marks can be saved. Additionally, every two rhombus shaped structure of the first sensing module 400 and the second sensing module 420 are separately disposed via a first distance of 30 um, and widths of the plurality of boundaries are equal to the first distance as 30 um, where the above number is disclosed as illustration and is not limiting the scope of the invention.

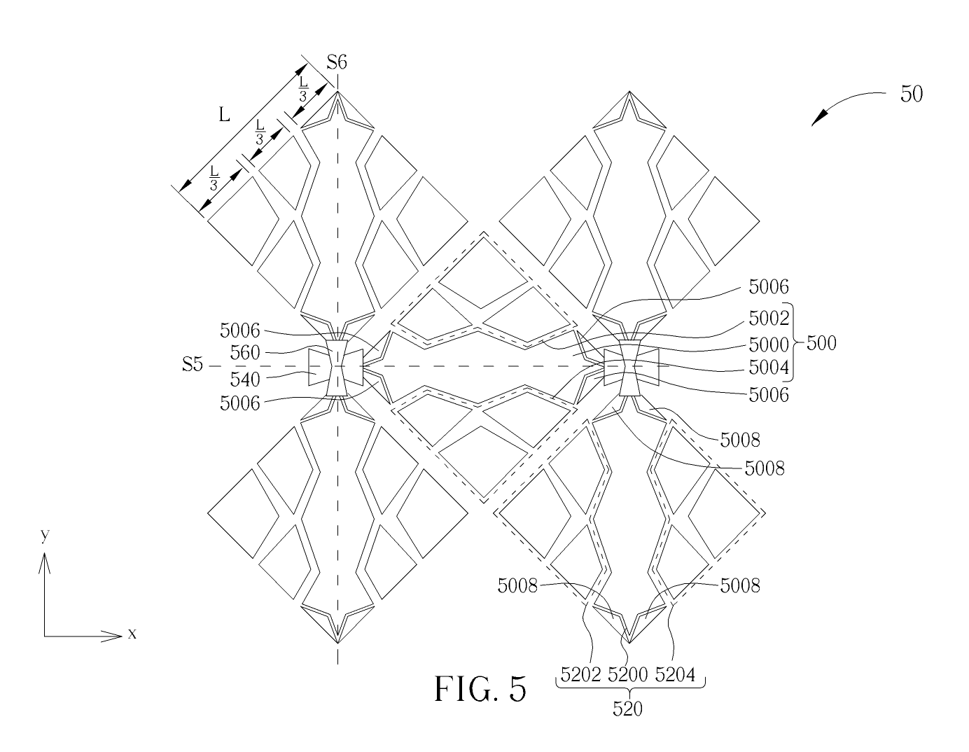

Please refer to FIG. 5, which illustrates a schematic diagram of another capacitive touch panel 50 according to an embodiment of the invention. As shown in FIG. 5, the capacitive touch panel 50, being similar to the capacitive touch panel 30 shown in FIG. 3, also comprises a plurality of first sensing channels S5 and a plurality of second sensing channels S6. Each first sensing channel S5 comprises a plurality of first sensing modules 500 and a plurality of first connecting units 540, and each second sensing channel S6 comprises a plurality of second sensing modules 520 and a plurality of second connecting units 560. Also, each first sensing module 500 is formed as a rhombus shaped structure and comprises a first sensing unit 5000, a plurality of first dummy units 5002 and a plurality of second dummy units 5004, and each second sensing module 520 is also formed as a rhombus shaped structure and comprises a second sensing unit 5200, a plurality of third dummy units 5202 and a plurality of fourth dummy units 5204. The plurality of first dummy units 5002, the plurality of second dummy units 5004, the plurality of third dummy units 5202 and the plurality of fourth dummy units 5204 are formed as quadrilaterals with a number of three. Noticeably, the first sensing unit 5000 further comprises a plurality of fifth dummy units 5006, which neighbor to an angle of the rhombus shaped structure to electrically connect to the plurality of first connecting units 540, and the second sensing unit 5200 further comprises a plurality of sixth dummy units 5008, which neighbor to an angle of the rhombus shaped structure to electrically connect to the plurality of second connecting units 560. In the meanwhile, a number of the plurality of fifth dummy units 5006 as well as the plurality of sixth dummy units 5008 is four, and a shape thereof is formed as a triangle. Besides, in comparison with the rectangular shaped structure of the plurality of first connecting units 340 as well as the plurality of second connecting units 360 shown in FIG. 3, the plurality of first connecting units 540 as well as the plurality of second connecting units 560 of the capacitive touch panel 50 further comprise a concave part (or a concave angle) to be formed on one side of the rectangular shaped structure, i.e. at least one side of the first connecting unit 540 (or the second connecting unit 560) comprises a stairway shape toward inside to form the concave part (or the concave angle).

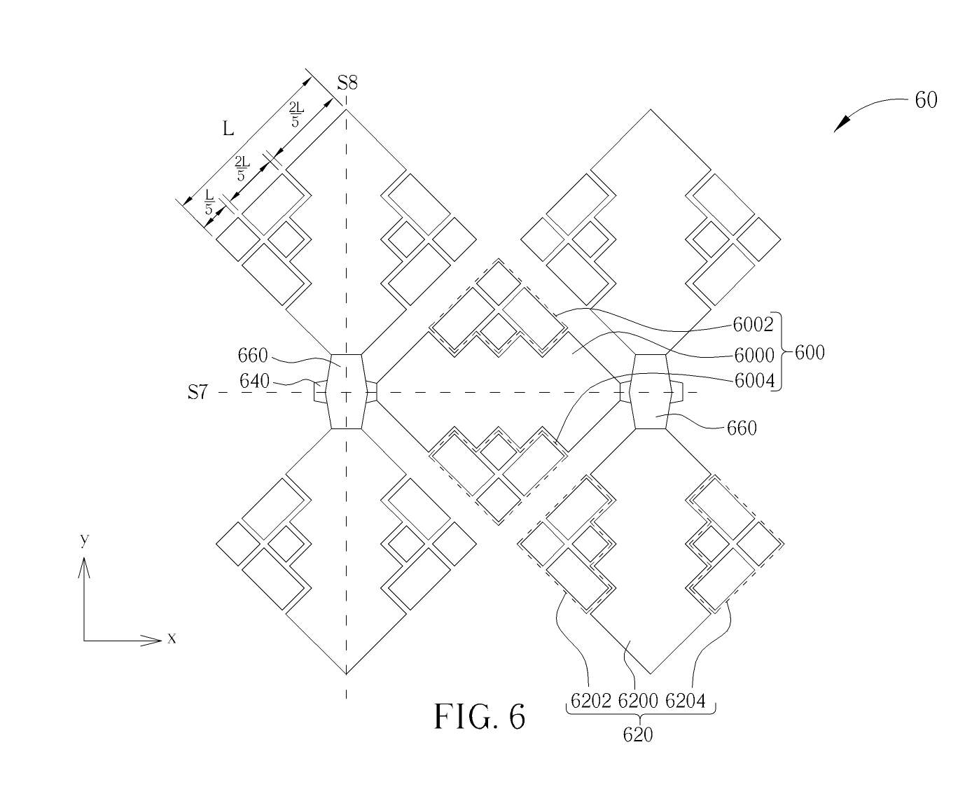

Please refer to FIG. 6, which illustrates a schematic diagram of another capacitive touch panel 60 according to an embodiment of the invention. As shown in FIG. 6, the capacitive touch panel 60, being similar to the capacitive touch panel 40 shown in FIG. 4, also comprises a plurality of first sensing channels S7 and a plurality of second sensing channels S8. Each first sensing channel S7 comprises a plurality of first sensing modules 600 and a plurality of first connecting units 640, and each second sensing channel S8 comprises a plurality of second sensing modules 620 and a plurality of second connecting units 660. Also, each first sensing module 600 comprises a first sensing unit 6000, a plurality of first dummy units 6002 and a plurality of second dummy units 6004, and each second sensing module 620 comprises a second sensing unit 6200, a plurality of third dummy units 6202 and a plurality of fourth dummy units 6204. The plurality of first dummy units 6002, the plurality of second dummy units 6004, the plurality of third dummy units 6202 and the plurality of fourth dummy units 6204 are formed shaped as quadrilaterals with a number of four. Noticeably, the plurality of first connecting units 640 as well as the plurality of second connecting units 660 of the capacitive touch panel 60 further comprise a convex part (or a convex angle) to be formed on one side of the rectangular shaped structure, i.e. at least one side of the first connecting unit 640 (or the second connecting unit 660) comprises a stairway shape toward outside to form the convex part (or the convex angle).

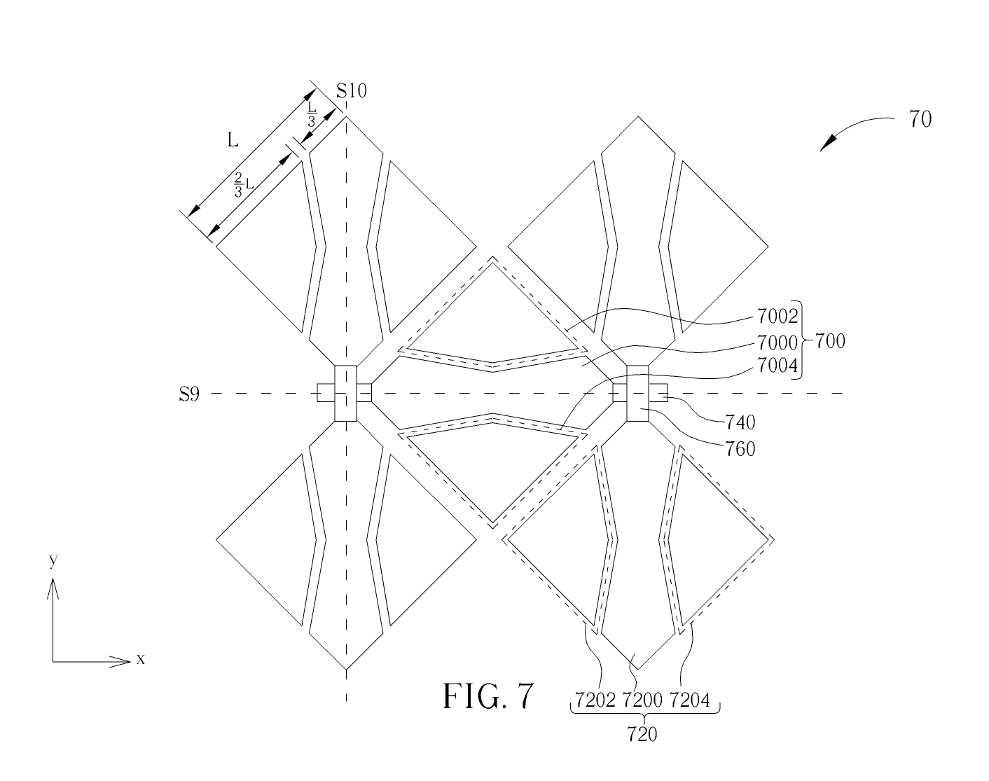

Please refer to FIG. 7, which illustrate a schematic diagram of another capacitive touch panel 70 according to an embodiment of the invention. In comparison with the capacitive touch panel 30 shown in FIG. 3, the capacitive touch panel 70 shown in FIG. 7 directly integrates the plurality of first dummy units 3002, the plurality of second dummy units 3004, the plurality of third dummy units 3202 and the plurality of fourth dummy units 3204 to be a first dummy unit 7002, a second dummy unit 7004, a third dummy unit 7202 and a fourth dummy unit 7204, and other elements/units share the same connection relationship as well as formation of the capacitive touch panel 30. Accordingly, the capacitive touch panel 70 is located on an XY plane to comprise a plurality of first sensing channels S9 and a plurality of second sensing channels S10. Each of the plurality of first sensing channels S9 comprises a plurality of first sensing modules 700 and a plurality of first connecting units 740, and each of the plurality of second sensing channels S10 comprises a plurality of second sensing modules 720 and a plurality of second connecting units 760, to form a plurality of vertical lines as well as a plurality of horizontal lines interlaced to each other as a chessboard. Additionally, each dummy unit is shaped as an asymmetrical quadrilateral, such that the plurality of boundaries are not parallel/perpendicular to the X-axis and the Y-axis to avoid generation of light interference. In the meanwhile, the symmetrical shaped structure of the plurality of first sensing modules 700 and the plurality of second sensing modules 720 is obtained as the rhombus shaped structure. In the embodiment, a side length of the first sensing unit 7000 and the second sensing unit 7200 is one third of a side length of the rhombus shaped structure. The first dummy unit 7002, the second dummy unit 7004, the third dummy unit 7202 and the fourth dummy unit 7204 comprise a plurality of side lengths to be two thirds of the side length of the rhombus shaped structure. Additionally, every two rhombus shaped structures of the first sensing module 700 and the second sensing module 720 are separately disposed via a first distance of 30 um, and widths of the plurality of boundaries are equal to the first distance as 30 um, where the above number is disclosed as illustration and is not limiting the scope of the invention.

Noticeably, those skilled in the art can adaptively combine/modify/adjust the embodiments shown in FIG. 3 to FIG. 7 to correspondingly derive embodiments, which comprise a plurality of boundaries being not parallel/perpendicular to the X-axis and the Y-axis and a plurality of connecting units comprising at least one side of the rectangle structure with adaptive adjustments, such as the stairway shape toward inside/outside to form the concave/convex part. Also, the derived embodiments can adaptively equip with different numbers or shape formation of the plurality of dummy units, and those skilled in the art can combine the concept of the invention with the plurality of dummy units from the prior art according to different practical requirements, such that the capacitive touch panel can be provided to comprise the two-layer structure with the higher accurate determination of the touch position as well as the symmetrical structure for reducing the generation of light interference and production cost, which is also in the scope of the invention.

In summary, embodiments of the invention provide a capacitive touch panel which comprises a plurality of symmetrical dummy units as well as a plurality of sensing units to obtain a plurality of sensing modules with the rhombus shaped structure. Thus, the capacitive touch panel in the embodiments of the invention can adaptively reduce the touch area as well as maintain the symmetrical structure to effectively reduce generation of light interference as well as noise signals, so as to improve the application range of the capacitive touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A capacitive touch panel, comprising:
a plurality of first sensing channels disposed along a first direction, and each of the plurality of first sensing channels comprising:
a plurality of first sensing modules, and each of the first sensing modules comprising:
a first sensing unit;
a plurality of first dummy units disposed to one side of the first sensing unit; and
a plurality of second dummy units disposed to another side of the first sensing unit;
wherein the plurality of first dummy units and the plurality of second dummy units are separately disposed to form a plurality of first boundaries, and a plurality of extension rays derived from the plurality of first boundaries and another extension ray of the first direction are interlaced to form a plurality of first angles being in the range from zero degrees to ninety degrees or from ninety degrees to a hundred and eighty degrees; and
a plurality of first connecting units disposed along the first direction for connecting the plurality of first sensing modules; and
a plurality of second sensing channels disposed along a second direction, and each of the plurality of second sensing channels comprising:
a plurality of second sensing modules, and each of the second sensing modules comprising:
a second sensing unit;
a plurality of third dummy units disposed to one side of the second sensing unit; and
a plurality of fourth dummy units disposed to another side of the second sensing unit;
wherein the plurality of third dummy units and the plurality of fourth dummy units are separately disposed to form a plurality of second boundaries, and a plurality of extension rays derived from the plurality of second boundaries and another ray of the second direction are interlaced to form a plurality of second angles being in the range from zero degrees to ninety degrees or from ninety degrees to a hundred and eighty degrees; and
a plurality of second connecting units disposed along the second direction for connecting the plurality of second sensing modules;
wherein the first direction is perpendicular to the second direction, such that the plurality of first sensing channels and the plurality of second sensing channels are perpendicular to each other on a projective plane.

2. The capacitive touch panel of claim 1, wherein each dummy unit of the plurality of first dummy units, second dummy units, third dummy units and fourth dummy units is shaped as a quadrilateral.

3. The capacitive touch panel of claim 2, wherein the quadrilateral comprises two obtuse angles and two acute angles.

4. The capacitive touch panel of claim 2, wherein a number of the plurality of first dummy units, second dummy units, third dummy units and fourth dummy units is three.

5. The capacitive touch panel of claim 4, wherein each of the plurality of first sensing channels further comprises a plurality of fifth dummy units connecting the plurality of first connecting units, and each of the plurality of second sensing channels further comprises a plurality of sixth dummy units connecting the plurality of second connecting units.

6. The capacitive touch panel of claim 5, wherein a number of the plurality of fifth dummy units and sixth dummy units is four and forms a triangular shape.

7. The capacitive touch panel of claim 2, wherein the quadrilateral comprises four right angles.

8. The capacitive touch panel of claim 7, wherein a number of the plurality of first dummy units, second dummy units, third dummy units and fourth dummy units is four.

9. The capacitive touch panel of claim 2, wherein each of the plurality of first sensing modules and second sensing modules is a rhombus in shape and comprises four sides with equal length.

10. The capacitive touch panel of claim 9, wherein the plurality of first sensing units, second sensing units, first dummy units, second dummy units, third dummy units and fourth dummy units each comprise at least a side being one third of the side of the rhombus.

11. The capacitive touch panel of claim 9, wherein the plurality of first sensing units, second sensing units, first dummy units, second dummy units, third dummy units and fourth dummy units each comprise at least a side being two fifths of the side of the rhombus.

12. The capacitive touch panel of claim 11, wherein the plurality of first sensing units, second sensing units, first dummy units, second dummy units, third dummy units and fourth dummy units each comprise at least a side being one fifth of the side of the rhombus.

13. The capacitive touch panel of claim 9, wherein the side of each of the plurality of first sensing modules corresponding to the rhombus and the side of each of the plurality of second sensing modules corresponding to the rhombus are separately disposed as a first distance.

14. The capacitive touch panel of claim 13, wherein each of the plurality of first boundaries and second boundaries comprises a boundary width being equal to the first distance.

15. The capacitive touch panel of claim 1, wherein each of the plurality of first connecting units and second connecting units is a rectangle.

16. The capacitive touch panel of claim 15, wherein at least one side of the rectangle forms as a stairway shape toward inside or outside to become a concave part or a convex part.
